(19) United States
(12) Patent Application Publication
(10) Pub. No.: US 2007/0242590 A1
(43) Pub. Date: Oct. 18, 2007

(54) OPTICAL SYSTEM FOR OPTICAL DISC DRIVE

(75) Inventors: Tomokazu KOIZUMI, Saitama (JP); Shuichi TAKEUCHI, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/735,588

(22) Filed: Apr. 16, 2007

(30) Foreign Application Priority Data
Apr. 18, 2006 (JP) 2006-114337

(51) Int. Cl. G11B 7/00

(52) U.S. Cl. 369/112.01; 369/112.23

(57) ABSTRACT

There is provided an optical system for an optical disc drive. The optical system is provided with a light source that emits a light beam, and an objective lens to which the light beam emitted by the light source enters. In this configuration, the light beam emitted by the light source is incident on the objective lens without passing through a coupling lens. Further, the optical system satisfies a condition:

−0.70≦d′/(ML′)≦−0.57 (1)
where d′ (mm) represents a center thickness of the objective lens corresponding to air, M represents magnification of the optical system, and L′ (mm) represents an object-to-image distance corresponding to air.

### BACKGROUND OF THE INVENTION

The present invention relates to an optical system used for an optical disc drive for recording data to and/or reproducing data from an optical disc having a high recording density.

Optical systems for an optical disc drive configured to have a light source, a coupling lens and an objective lens have been widely used. The term “coupling lens” means a lens serving to convert a light beam emitted by the light source into a collimated beam or a lens having a function of changing the degree of divergence of a beam (i.e., changing magnification of the optical system). The coupling lens is used to suppress aberration caused on a recording surface of the optical disc, or to enhance efficiency of used of light in the optical disc drive. Recently, optical systems are required to decrease the number of optical components to achieve cost reduction and downsizing. In each of Japanese Patent Provisional Publications Nos. SHO 61-56314 and HEI 8-334686, a finite optical system is disclosed. The finite optical systems disclosed in these publications are configured not to have a coupling lens.

Regarding an optical system for an optical disc drive supporting recordation and reproduction for both of CD and DVD, the above mentioned need (i.e., cost reduction and downsizing) is stressed.

Although an optical system not having a coupling lens is able to reduce the cost and size thereof, such an optical system has a drawback that when an objective lens is shifted in a direction perpendicular to an optical axis of the objective lens for tracking, the optical system produces off-axis aberration, notably astigmatism, in comparison with an infinite optical system employing a coupling lens. The finite optical system is required to suitably suppress the astigmatism caused by off-axis light. Japanese Patent Provisional Publication No. 2005-18966 discloses a finite optical system configured to suppress astigmatism caused by off-axis light.

However, for recording information on an optical disc having a high recording density such as a DVD, it is required to form a small beam spot through use of an objective lens having a high NA (Numerical Aperture). Therefore, regarding an optical system performing recordation or reproduction in high NA, it is required to suppress astigmatism more effectively.

### SUMMARY OF THE INVENTION

The present invention is advantageous in that it provides an optical system capable of suitably suppressing off-axis aberration such as astigmatism caused in an optical disc drive when recordation or reproduction for an optical disc having a high recording density is performed.

According to an aspect of the invention, there is provided an optical system for an optical disc drive. The optical system is provided with a light source that emits a light beam, and an objective lens to which the light beam emitted by the light source enters. In this configuration, the light beam emitted by the light source is incident on the objective lens without passing through a coupling lens. Further, the optical system satisfies a condition:

−0.70≦d′/(ML′)≦−0.57 (1)

where d′ (mm) represents a center thickness of the objective lens corresponding to air, M represents magnification of the optical system, and L′ (mm) represents an object-to-image distance corresponding to air.

By thus determining the center thickness of the objective lens to satisfy the condition (1), it is possible to suitably suppress astigmatism caused when the objective lens is moved for a tracking operation.

According to another aspect of the invention, there is provided an optical system for an optical disc drive for recording data to and/or reproducing data from at least two types of optical discs having different thicknesses of cover layers. The optical system is provided with a light source having light emitting portions which emit light beams having wavelengths respectively corresponding to the at least two types of optical discs, and an objective lens to which the light beams emitted by the light source enter. In this configuration, each of the light beams emitted by the light source is incident on the objective lens without passing through a coupling lens. The optical system satisfies a condition:

−0.70≦d′/(ML′)≦−0.57 (1)

where d′ (mm) represents a center thickness of the objective lens corresponding to air, M represents magnification defined in a state where a light beam emitted by the light source is converged onto a recording surface of an optical disc having a relatively thin cover layer with almost no aberration, and L′ (mm) represents an object-to-image distance corresponding to air.

By thus determining the center thickness of the objective lens to satisfy the condition (1), it is possible to suitably suppress astigmatism caused when the objective lens is moved for a tracking operation. Astigmatism needs to be suitably corrected particularly for the optical disc which has a relatively thin cover layer and a relatively high recording density. Therefore, by thus configuring the optical disc drive supporting the plurality of types of optical discs to satisfy the condition (1) at least for the optical disc having the relatively thin cover layer, it is possible to suitably suppress aberration while achieving downsizing of the optical system.

In at least one aspect, the light emitting portions are arranged along a line which is perpendicular to a first direction, in which the objective lens is allowed to move perpendicularly to a recording surface of an optical disc being used, and is perpendicular to a second direction in which the objective lens is allowed to move in parallel with the recording surface of the optical disc being used.

According to another aspect of the invention, there is provided an optical system for an optical disc drive. The optical system is provided with a light source that emits a light beam, and an objective lens to which the light beam emitted by the light source enters. In this configuration, the light beam emitted by the light source is unrefracted by a lens and incident on the objective lens. The optical system satisfies a condition:

−0.70≦d′/(ML′)≦−0.57 (1)

where d′ (mm) represents a center thickness of the objective lens corresponding to air, M represents magnification of the optical system, and L′ (mm) represents an object-to-image distance corresponding to air.

By thus determining the center thickness of the objective lens to satisfy the condition (1), it is possible to suitably suppress astigmatism caused when the objective lens is moved for a tracking operation.

According to another aspect of the invention, there is provided an optical system for an optical disc drive for recording data to and/or reproducing data from at least two types of optical discs having different thicknesses of cover layers. The optical system is provided with a light source having light emitting portions which emit light beams having wavelengths respectively corresponding to the at least two types of optical discs, and an objective lens to which the light beams emitted by the light source enter. In this configuration, each of the light beams emitted by the light source is unrefracted by a lens and incident on the objective lens. The optical system satisfies a condition:

−0.70≦d′/(ML′)≦−0.57 (1)

where d′ (mm) represents a center thickness of the objective lens corresponding to air, M represents magnification defined in a state where a light beam emitted by the light source is converged onto a recording surface of an optical disc having a relatively thin cover layer with almost no aberration, and L′ (mm) represents an object-to-image distance corresponding to air.

By thus determining the center thickness of the objective lens to satisfy the condition (1), it is possible to suitably suppress astigmatism caused when the objective lens is moved for a tracking operation. Astigmatism needs to be suitably corrected particularly for the optical disc which has a relatively thin cover layer and a relatively high recording density. Therefore, by thus configuring the optical disc drive supporting the plurality of types of optical discs to satisfy the condition (1) at least for the optical disc having the relatively thin cover layer, it is possible to suitably suppress aberration while achieving downsizing of the optical system.

### BRIEF DESCRIPTION OF THE ACCOMPANYING DRAWINGS

FIG. 1 is a block diagram of an optical system according to a first embodiment.

FIG. 2 is a graph illustrating a relationship between astigmatism and d′/(ML′) for each of magnifications of −0.07, −0.1109, and −0.1538.

FIG. 3 is a block diagram of an optical system according to a second embodiment.

FIG. 4 is an enlarged view of a cross section of a surface of an objective lens taken along a plane including an optical axis of the objective lens.

FIG. 5 is a graph showing astigmatism caused in an optical system according to a first example, assuming that the maximum object height of the objective lens is 400 μm.

FIG. 6 illustrates comparative example of an optical system which does not satisfy a condition (1).

FIG. 7 is a graph showing astigmatism caused in the comparative example shown in FIG. 6 when an optical disc having a relatively high recording density is used.

FIG. 8A shows a configuration of an optical system according to a second example, in regard to an optical path defined when an optical disc having a relatively high recording density is used.

FIG. 8B shows a configuration of the optical system according to the second example, in regard to an optical path defined when the optical disc having a relatively low recording density is used.

FIG. 9A shows a configuration of an optical system according to a third example, in regard to an optical path defined when an optical disc having a relatively high recording density is used.

FIG. 9B shows a configuration of the optical system according to the third example, in regard to an optical path defined when the optical disc having a relatively low recording density is used.

FIG. 10A shows a configuration of an optical system according to a fourth example, in regard to an optical path defined when an optical disc having a relatively high recording density is used.

FIG. 10B shows a configuration of the optical system according to the fourth example, in regard to an optical path defined when the optical disc having a relatively low recording density is used.

FIG. 11 shows a graph of astigmatism caused in the optical system according to the second example when the maximum object height of the objective lens is 400 μm.

FIG. 12 shows a graph of astigmatism caused in the optical system according to the third example when the maximum object height of the objective lens is 400 μm.

FIG. 13 shows a graph of astigmatism caused in the optical system according to the fourth example when the maximum object height of the objective lens is 400 μm.

### DETAILED DESCRIPTION OF THE EMBODIMENTS

Hereinafter, embodiments according to the invention are described with reference to the accompanying drawings.

In this specification, the term “optical disc drive” includes an optical disc drive designed specifically for recording data to an optical disc, an optical disc drive specifically designed for reproducing data from an optical disc, and an optical disc drive having both of functions of recording data to and reproducing data from an optical disc.

### First Embodiment

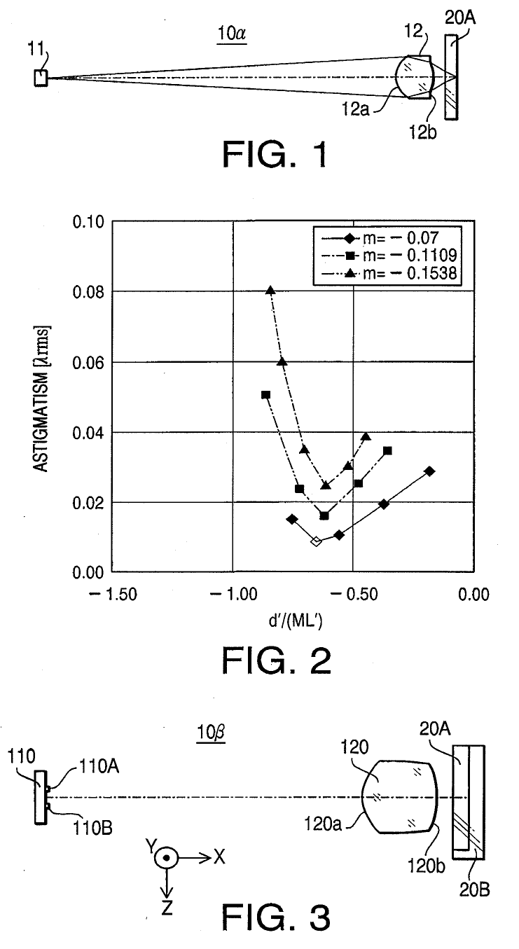

FIG. 1 is a block diagram of an optical system 10α according to a first embodiment. In FIG. 1, an optical disc 20A having a relatively high recording density and having a relatively thin cover layer (e.g., a DVD) is also illustrated. The optical system 10α includes a light source 11 and an objective lens 12. The optical system 10α is mounted on an optical disc drive capable of recording data to and/or reproducing data from the optical disc 20A which is placed on a turn table (not shown) of the optical disc drive.

As shown in FIG. 1, the optical system 10α is a finite system not having a coupling lens. In other words, a laser beam emitted by the light source 11 is incident on the objective lens 12 without passing through a coupling lens. In the optical system 10α, a laser beam emitted by the light source 11 is a diverging beam, and the diverging beam is converged only by the objective lens 12. The light source 11 emits the laser beam having a relatively short wavelength so that the laser beam forms a beam spot having a relatively small diameter on a recording surface of the optical disc 20A.

The objective lens 12 has a surface (a light source side surface) 12a and a surface (an optical disc side surface) 12b. Each of the surfaces 12a and 12b is formed to be an aspherical surface. On at least one of the surfaces 12a and 12b of the objective lens 12, a diffracting structure having a plurality of annular zones divided by minute steps concentrically formed about an optical axis of the objective lens 12 is formed. The diffracting structure is configured to have a function of correcting a spherical aberration caused in the objective lens 12 by temperature change. More specifically, the diffracting structure of the objective lens 12 corrects the spherical aberration caused in the objective lens 12 due to a change of a refraction index and a change of linear expansion of the objective lens 12 associated with a temperature change, by canceling the spherical aberration caused in the objective lens 12 with a change of spherical aberration caused in the diffracting structure due to a change of the wavelength of the laser beam emitted by the light source 11 associated with the temperature change. Therefore, the diffracting structure enables the optical system 10α to form a suitable beam spot on the recording surface of the optical disc 20A over a wide temperature range.

When the objective lens 12 shifts in a direction perpendicular to the optical axis of the objective lens 12, off-axis aberrations such as astigmatism are caused. In this embodiment, the astigmatism is corrected by adjusting a thickness of the objective lens 12. However, if the thickness of the objective lens 12 is increased excessively, weight of the objective lens 12 may become excessively larger or the objective lens 12 may become unable to secure a sufficient working distance. For this reason, the optical system 10α is configured to satisfy a condition:

−0.70≦d′/(ML′)≦−0.57 (1)

where d′ (mm) represents a center thickness of the objective lens 12 corresponding to air, M represents magnification of the optical system 10α, and L′ (mm) represents an object-to-image distance (a distance between an object and an image) corresponding to air. Such a thickness d′ and the object-to-image distance L′ can be obtained in accordance with an expression Σ(t/n) when a thickness of a medium is represented by t (mm) and a refractive index of a material in a design wavelength is represented by n.

FIG. 2 is a graph illustrating a relationship between astigmatism and d′/(ML′) for each of magnifications of −0.07, −0.1109, and −0.1538. In FIG. 2, a horizontal axis represents a value d′/(ML′) in the condition (1), and a vertical axis represents the astigmatism (unit: λrms). As shown in FIG. 2, the astigmatism varies depending on the value of the magnification. Regardless of the value of the magnification, each of curves takes a minimum value at the same value of d′/(ML′).

As described above, the condition (1) is defined based on the relationship between the magnification and the astigmatism. Therefore, by determining the center thickness d′ corresponding to air of the objective lens 12 to satisfy the condition (1), it becomes possible to sufficiently suppress the astigmatism caused in a tracking operation while securing a suitable working distance, regardless of the value of the magnification.

If d′ is excessively increased and thereby d′/(ML′) gets out from the lower limit of the condition (1), weight of the objective lens 12 becomes excessively large or it becomes impossible to secure a sufficient working distance. If d′ is excessively decreased and thereby d′/(ML′) gets out from the upper limit of the condition (1), the effect of controlling the astigmatism by the thickness of the objective lens decreases.

### Second Embodiment

FIG. 3 is a block diagram of an optical system 10β according to a second embodiment. In FIG. 3, an optical disc 20A having a relatively high recording density (e.g., a DVD) and an optical disc 20B having a relatively low recording density are illustrated. The optical disc 20B is, for example, a CD having a cover layer thickness larger than that of the optical disc 20A. The optical system 10 includes a light source 110 and an objective lens 120. The optical disc 10β is mounted on an optical disc drive capable of recording data to and/or reproducing data from a plurality of types of optical discs (i.e., the optical discs 20A and 20B). The optical disc is placed on a turn table (not shown) of the optical disc drive.

The light source 110 has two light emitting portions 110A and 110B arranged along a line (i.e., Z-axis direction) which is perpendicular to a X-axis direction, in which the objective lens 120 is allowed to move perpendicularly to a recording surface of the optical disc being used, and is perpendicular to an Y-axis direction in which the objective lens 120 is allowed to move in parallel with the recording surface of the optical disc being used. By thus arranging the light emitting portions 110A and 110B in the optical system 10β, it is possible to prevent an image height from becoming excessively large when the objective lens 120 shifts in the tracking operation.

In other words, by thus arranging the light emitting portions of the light source, it is possible to make a line in which the light emitting portions 110A and 110B are arranged not coincide with a direction of the tracking operation. Therefore, it is possible to prevent the phenomenon, where aberration becomes excessively large due to an excessive larger image height caused by the tracking operation, from occurring in the optical system.

When the recording operation or reproducing operation for the optical disc 20A having a relatively high recording density is performed, the light emitting portion 110A is activated to emit the laser beam (hereafter, referred to as a first laser beam) having a relatively short wavelength so that a beam spot having a relatively small diameter is formed on the recording surface of the optical disc 20A. The wavelength of the first laser beam emitted by the light emitting portion 110A is substantially the same as that of the laser beam emitted by the light source 11 of the first embodiment.

When the recording operation or reproducing operation for the optical disc 20B having a relatively low recording density is performed, the light emitting portion 110B is activated to emit the laser beam (hereafter, referred to as a second laser beam) having a relatively long wavelength so that a beam spot having a relatively large diameter is formed on the recording surface of the optical disc 20B.

The objective lens 120 has a surface (a light source side surface) 120a and a surface (an optical disc side surface) 120b. On at least one of the surfaces 120a and 120b of the objective lens 120, a diffracting structure having a plurality of annular zones divided by minute steps concentrically formed about the optical axis of the objective lens 120 is formed.

Since the thicknesses of the cover layers of the optical discs 20A and 20B are different from each other, the spherical aberration changes depending on the type of the optical disc being used. The diffracting structure formed on the objective lens 120 is configured to have a function of correcting change of the spherical aberration caused by the difference of the thickness of the cover layer, through use of diffraction effect.

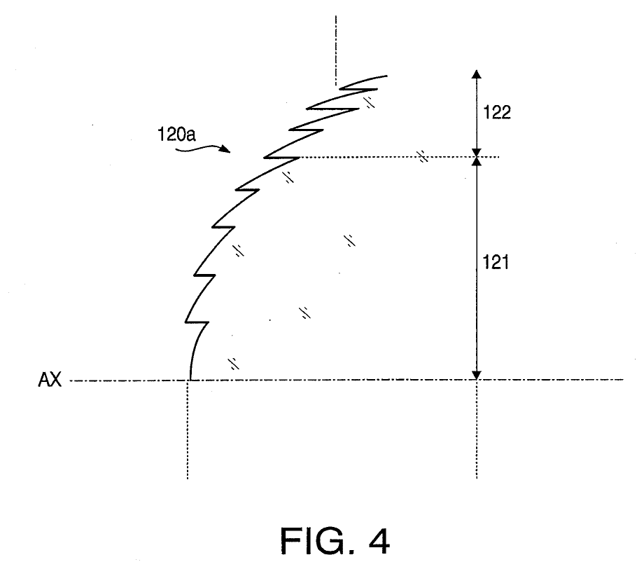

FIG. 4 is an enlarged view of a cross section of the surface 120a taken along a plane including the optical axis of the objective lens 120. In FIG. 4, a structure of the surface 120a in the vicinity of the optical axis is illustrated.

As shown in FIG. 4, the surface 120a is divided into an inner area 121 formed around the optical axis AX and an outer area 122 formed outside the inner area 121, Each of the inner area 121 and the outer area 122 has a plurality of annular zones divided by minute steps. The diffracting structure formed in the inner area 121 is configured such that the first laser beam from the light emitting portion 110A is suitably converged on the recording surface of the optical disc 20A with almost no aberration, and that the second laser beam from the light emitting portion 110B is suitably converged on the recording surface of the optical disc 20B with almost no aberration. The diffracting structure formed in the outer area 122 is configured such that the first laser beam from the light emitting portion 110A is suitably converged on the recording surface of the optical disc 20A.

With this structure, the first laser beam passed through both of the inner and outer areas 121 and 122 forms a small beam spot on the recording surface of the optical disc 20A while achieving a high numerical aperture (NA). On the other hand, the second laser beam passed through the outer area 122 is diffused on the recording surface of the optical disc 20B because in this case a large amount of spherical aberration is generated. That is, when the second laser beam is used, only the second laser beam passed through the surface 120a within the inner area 121 contributes the formation of the relatively large beam spot.

Similarly to the first embodiment, the optical system 10β according to the second embodiment is configured to satisfy the above mentioned condition (1) at least when the optical disc 20A having a relatively high recording density is used. With this configuration, it is possible to sufficiently suppress the astigmatism caused by off-axis light even if a coupling lens is omitted.

Hereafter, a concrete example (first example) according to the first embodiment and three concrete examples (second, third and fourth examples) according to the second embodiment are described.

### FIRST EXAMPLE

Since a first example is a concrete example of the optical system 10α according to the first embodiment, a configuration of the first example is explained with reference to FIG. 1. Specifications of the optical system 10α according to the first example are shown in Table 1.

TABLE 1

| | Optical Disc 20A |
|---|---|
| M | −0.1005 |
| Design wavelength (nm) | 655 |
| NA | 0.60 |
| L′ (mm) | 19.5308 |

In Table 1 (and in the following similar Tables), the design wavelength is a wavelength suitable for the recording/reproducing operation of the optical disc, M represents magnification of the optical system 10α, NA represents the numerical aperture, and L′ represents the object-to-image distance corresponding to air. Table 2 shows a numerical configuration of the optical system 10α.

TABLE 2

| Surface | | | n | |
|---|---|---|---|---|
| Number | r | d | (405 nm) | comments |
| #0 | | 17.4090 | | light source |
| #1 | 1.1970 | 1.8500 | 1.54063 | objective lens |
| #2 | −1.6030 | 0.5412 | | |
| #3 | ∞ | 0.6000 | 1.57995 | optical disc |
| #4 | | — | | |

In Table 2 (and in the following similar Tables), “r” represents a radius of curvature (unit: mm) of each lens surface on the optical axis, “d” represents a thickness of a lens or a distance (unit: mm) from a lens surface to a next lens surface, and “n” represents a refractive index. In Table 2 (and in the following similar Tables), surface #0 represents the light source (the light source 11 in this example), surfaces #1 and #2 respectively represent front and rear surfaces of the objective lens (the surface 12a and 12b of the objective lens 12 in this example), surface #3 represents the cover layer of the optical disc being used, and surface #4 represents the recording surface of the optical disc being used.

Each of the surfaces 12a (#1) and 12b (#2) of the objective lens 12 is an aspherical surface. An aspherical surface is expressed by a following expression:

$$X ( h ) = \frac{{ch}^{2}}{1 + \sqrt{1 - ( 1 + K ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + …$$

where, X(h) represents a SAG amount which is a distance between a point on the aspherical surface at a height of h from the optical axis and a plane tangential to the aspherical surface at the optical axis, symbol c represents curvature (1/r) on the optical axis, K is a conical coefficient, and A₄, A₆, A₈, A₁₀ and A₁₂ are aspherical coefficients of fourth, sixth, eighth, tenth and twelfth orders, respectively.

Table 3 shows the conical coefficient and aspherical coefficients defining the surfaces 12a (#1) and 12b (#2) of the objective lens 12. In Table 3 (and in the following similar Tables), a notation symbol E indicates that 10 is used as a radix and a right side value of E is used as an exponent.

TABLE 3

| SURFACE | COEFFICIENT | | | | | |
|---|---|---|---|---|---|---|
| NO. | K | A4 | A6 | A8 | A10 | A12 |
| 1 | −1.05 | 2.6420E−02 | 1.9790E−03 | −2.5130E−03 | 5.2210E−05 | −9.2810E−04 |
| 2 | −0.45 | 3.1840E−01 | −4.3220E−01 | 4.6990E−01 | −3.4330E−01 | 1.2000E−01 |

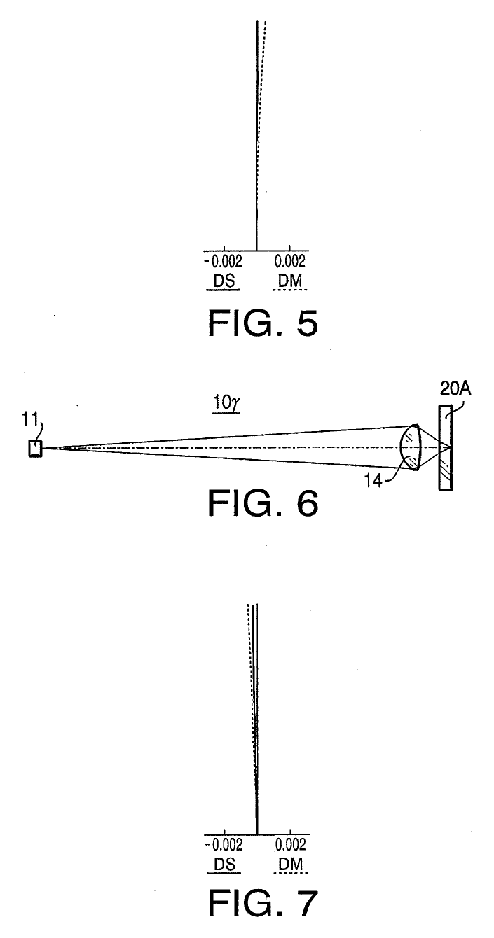

Regarding the optical system 10α according to the first example, d′/(ML′) takes −0.61. Therefore, the optical system 10α according to the first example satisfies the condition (1). FIG. 5 is a graph showing astigmatism caused in the optical system 10α, assuming that the maximum object height of the objective lens 12 is 400 μm. In FIG. 5 (and in the following similar tables), a curve indicated by a solid line represents a sagittal image surface, and a curve indicated by a dashed line represents a meridional image surface.

As a comparative example, FIG. 6 illustrates an optical system 10γ which does not satisfy the condition (1). In FIG. 6, to elements which are substantially the same as those of the first embodiment, the same reference numbers are assigned. FIG. 7 is a graph showing astigmatism caused in the optical system 10γ shown in FIG. 6 when the optical disc 20A is used.

Since the optical system 10γ does not satisfy the condition (1), the astigmatism in the meridional image surface is in an undercorrected condition. Such an undercorrected condition of astigmatism in the meridional image surface is undesirable. By contrast, according to the first example, astigmatism in the meridional image surface is in a slightly overcorrected condition. In each of FIGS. 5 and 7, the astigmatism is evaluated only for a third order component thereof. In general, if astigmatism is evaluated up to a high order component, a condition where the third order component is in an overcorrected condition represents a state where the astigmatism is suitably corrected. Therefore, the graph of astigmatism shown in FIG. 6 represents that the astigmatism is suitably corrected in the optical system 10α according to the first example.

As described above, according to the optical system 10α, downsizing and cost reduction can be achieved by eliminating the need for a coupling lens. In addition, by satisfying the condition (1), the optical system 10α effectively corrects the astigmatism which is caused in a tracking operation. Therefore, the optical system 10α is able to form, on the recording surface of the optical disc 20A, a small beam spot suitable for the recording operation and reproducing operation.

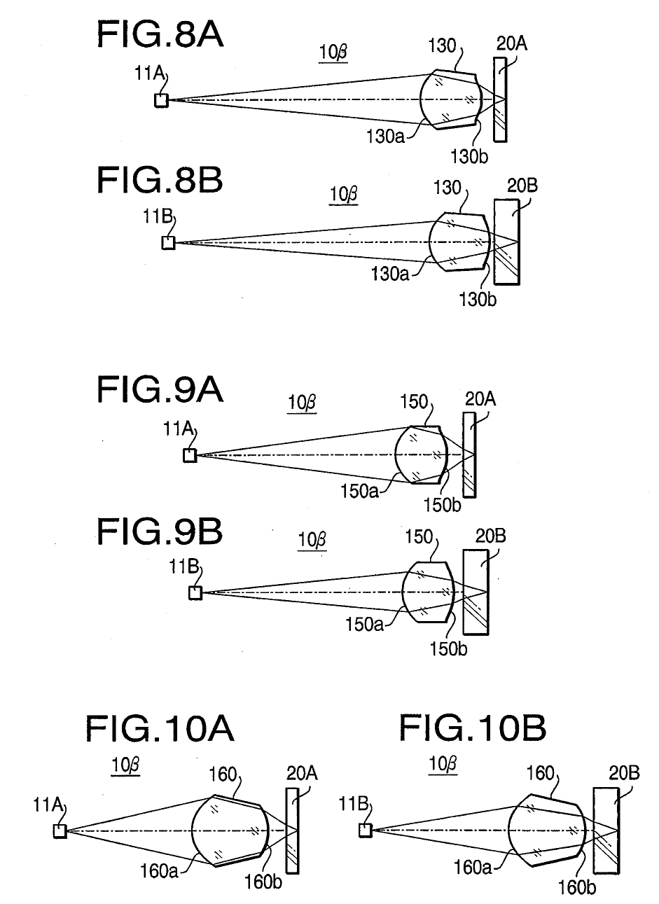

Hereafter, the second to fourth examples according to the second embodiment are described. FIGS. 8A and 8B are block diagrams of an optical system 10β according to a second example. More specifically, FIG. 8A shows a configuration of the optical system 10β according to the second example, in regard to an optical path defined when the optical disc 20A is used. FIG. 8B shows a configuration of the optical system 10β according to the second example, in regard to an optical path defined when the optical disc 20B is used.

FIGS. 9A and 9B are block diagrams of an optical system 10β according to a third example. More specifically, FIG. 9A shows a configuration of the optical system 10β according to the third example, in regard to an optical path defined when the optical disc 20A is used is illustrated. FIG. 9B shows a configuration of the optical system 10β according to the third example, in regard to an optical path defined when the optical disc 20B is used.

FIGS. 10A and 10B are block diagrams of an optical system 10β according to a fourth example. More specifically, FIG. 10A shows a configuration of the optical system 10β according to the fourth example, in regard to an optical path defined when the optical disc 20A is used. FIG. 10B shows a configuration of the optical system 10β according to the fourth example, in regard to an optical path defined when the optical disc 20B is used.

### SECOND EXAMPLE

Specifications of the optical system 10β according to the second example are shown in Table 4. Table 5 shows a numerical configuration of the optical system 10β according to the second example.

TABLE 4

| | Optical Disc 20A | Optical Disc 20B |
|---|---|---|
| M | −0.1798 | −0.1739 |
| Design wavelength (nm) | 655 | 780 |
| NA | 0.60 | 0.46 |
| L′ (mm) | 15.8729 | 16.2608 |

TABLE 5

| | |
|---|---|
| D | n |

| SURFACE | | Optical Disc | Optical Disc | Optical Disc | Optical Disc | |
|---|---|---|---|---|---|---|
| No. | r | 20A | 20B | 20A | 20B | |
| 0 | | 12.8290 | 13.2050 | | | light source |
| 1 (h ≦ 1.200) | 1.5200 | 3.0810 | | 1.54063 | 1.53677 | objective lens |
| 1 (h ≦ 1.470) | 1.5640 | | | | | |
| 2 | −1.5310 | 0.6643 | 0.2883 | | | |
| 3 | ∞ | 0.6000 | 1.2000 | 1.57995 | 1.57346 | optical disc |

| | |
|---|---|
| 4 | — |

Each of surfaces 130a (#1) and 130b (#2) of an objective lens 130 according to the second example is an aspherical surface. Table 6 shows the conical coefficient and aspherical coefficients defining the surfaces 130a (#1) and 130b (#2) of the objective lens 130.

TABLE 6

| SURFACE | COEFFICIENT | | | | | |
|---|---|---|---|---|---|---|
| No. | K | A4 | A6 | A8 | A10 | A12 |
| 1 (h ≦ 1.200) | −0.50 | −2.0130E−02 | −1.7070E−03 | −3.8050E−04 | −4.8150E−04 | 8.7220E−05 |
| 1 (h ≦ 1.470) | −0.50 | −2.1730E−03 | −9.8610E−03 | 1.8690E−03 | −6.1050E−04 | 1.3830E−04 |
| 2 | 0.00 | 3.1000E−01 | −2.9630E−01 | 2.2620E−01 | −8.3760E−02 | 1.1750E−02 |

In this example, a diffracting structure is formed on the surface 130a (#1) of the objective lens 130. A diffracting structure is expressed by an optical path difference function φ(h):

φ(h)=(P₂h²+P₄h⁴+P₆h⁶+P₈h⁸+P₁₀h¹⁰+P₁₂h¹²)mλ

where P₂, P₄ and P₆ . . . are coefficients of second, fourth, sixth . . . orders, h represents a height from the optical axis, m represents a diffraction order to be utilized, and λ represents a working wavelength of a laser beam being used. That is, the optical path difference function φ(h) represents the function as a diffraction lens by means of an additional optical path length. Table 7 shows the coefficients of the diffracting structure formed on the surface 130a of the objective lens 130.

TABLE 7

| | COEFFICIENT OF | | | | |
|---|---|---|---|---|---|
| SURFACE | OPTICAL PATH DIFFERENCE FUNCTION | | | | |
| No. | P2 | P4 | P6 | P8 | P10 |
| 1 (h ≦ 1.200) | 3.1130E+00 | −8.5570E+00 | −3.4820E−02 | −1.7860E−01 | 0.00E+00 |
| 1 (h ≦ 1.470) | −4.5250E+00 | 5.3230E+00 | −7.3250E+00 | 1.6180E+00 | 0.00E+00 |

As shown in Tables 5 to 7, the surface 130a of the objective lens 130 has an inner area (h≦1.200) and an outer area (1.200<h≦1.470). Aspherical shapes of the inner area and the outer area are different from each other. Diffracting structures of the inner area and the outer area are different from each other.

### THIRD EXAMPLE

Specifications of the optical system 10β according to a third example are shown in Table 8. Table 9 shows a numerical configuration of the optical system 10β according to the third example.

TABLE 8

| | Optical Disc 20A | Optical Disc 20B |
|---|---|---|
| M | −0.2296 | −0.2199 |
| Design wavelength (nm) | 655 | 780 |
| NA | 0.60 | 0.46 |
| L′ (mm) | 12.9676 | 13.3548 |

TABLE 9

| | | D | | n | | |
|---|---|---|---|---|---|---|
| SURFACE | | Optical Disc | Optical Disc | Optical Disc | Optical Disc | |
| No. | r | 20A | 20B | 20A | 20B | |
| 0 | | 10.0120 | 10.3975 | | | light source |
| 1 (h ≦ 1.150) | 1.4690 | 2.6190 | | 1.54063 | 1.53677 | objective lens |
| 1 (h ≦ 1.498) | 1.4870 | | | | | |
| 2 | −1.7570 | 0.8759 | 0.4904 | | | |
| 3 | ∞ | 0.6000 | 1.2000 | 1.57995 | 1.57346 | optical disc |

| | |
|---|---|
| 4 | — |

Each of surfaces 150a (#1) and 150b (#2) of an objective lens 150 according to the third example is an aspherical surface. Table 10 shows the conical coefficient and aspherical coefficients defining the surfaces 150a (#1) and 150b (#2) of the objective lens 150.

TABLE 10

| SURFACE | COEFFICIENT | | | | | |
|---|---|---|---|---|---|---|
| No. | K | A4 | A6 | A8 | A10 | A12 |
| 1 (h ≦ 1.150) | −0.50 | −2.5720E−02 | −1.5070E−03 | −1.3410E−05 | −7.8700E−04 | 1.5250E−04 |
| 1 (h ≦ 1.498) | −0.50 | −1.7930E−02 | −2.6880E−03 | 1.7940E−04 | −5.5780E−04 | 9.1470E−05 |
| 2 | 0.00 | 1.8670E−01 | −1.0960E−01 | 4.9470E−02 | −8.9450E−03 | 2.0420E−04 |

In this example, a diffracting structure is formed on the surface 150a (#1) of the objective lens 130. Table 11 shows the coefficients of the diffracting structure formed on the surface 150a of the objective lens 150.

TABLE 11

| | COEFFICIENT OF OPTICAL | | | | |
|---|---|---|---|---|---|
| SURFACE | PATH DIFFERENCE FUNCTION | | | | |
| No. | P2 | P4 | P6 | P8 | P10 |
| 1 (h ≦ 1.150) | 9.2090E−01 | −9.2750E+00 | 2.9600E−01 | −1.1960E−01 | 0.0000E+00 |
| 1 (h ≦ 1.498) | −2.4800E+00 | −3.2820E+00 | −1.1120E+00 | 2.6670E−01 | 0.0000E+00 |

As shown in Tables 9 to 11, the surface 150a of the objective lens 150 has an inner area (h≦1.150) and an outer area (1.150<h≦1.498). Aspherical shapes of the inner area and the outer area are different from each other. Diffracting structures of the inner area and the outer area are different from each other.

### FOURTH EXAMPLE

Specifications of the optical system 10β according to a fourth example are shown in Table 12. Table 13 shows a numerical configuration of the optical system 10β according to the fourth example.

TABLE 12

| | Optical Disc 20A | Optical Disc 20B |
|---|---|---|
| M | −0.4000 | −0.3747 |
| Design wavelength (nm) | 655 | 780 |
| NA | 0.60 | 0.46 |
| L′ (mm) | 10.0810 | 10.4703 |

TABLE 13

| | | d | | n | | |
|---|---|---|---|---|---|---|
| SURFACE | | Optical Disc | Optical Disc | Optical Disc | Optical Disc | |
| No. | r | 20A | 20B | 20A | 20B | |
| 0 | | 6.3110 | 6.7400 | | | light source |
| 1 (h ≦ 1.300) | 1.5140 | 3.8520 | | 1.54063 | 1.53677 | objective lens |
| 1 (h ≦ 1.825) | 1.5740 | | | | | |
| 2 | −1.3800 | 0.8900 | 0.4610 | | | |
| 3 | ∞ | 0.6000 | 1.2000 | 1.57995 | 1.57346 | optical disc |

| | |
|---|---|
| 4 | — |

Each of surfaces 160a (#1) and 160b (#2) of an objective lens 160 according to the fourth example is an aspherical surface. Table 14 shows the conical coefficient and aspherical coefficients defining the surfaces 160a (#1) and 160b (#2) of the objective lens 160.

TABLE 14

| SURFACE | COEFFICIENT | | | | | |
|---|---|---|---|---|---|---|
| No. | K | A4 | A6 | A8 | A10 | A12 |
| 1 (h ≦ 1.300) | −0.50 | −3.0100E−02 | 1.2510E−03 | −1.6460E−03 | 4.4840E−04 | −4.637E−05 |
| 1 (h ≦ 1.825) | −0.50 | −7.6890E−03 | −8.6040E−03 | 1.1480E−03 | 1.3230E−04 | −5.274E−05 |
| 2 | 0.00 | 2.9720E−01 | −2.2290E−01 | 2.1360E−01 | −1.1310E−01 | 2.826E−02 |

In this example, a diffracting structure is formed on the surface 160a (#1) of the objective lens 160. Table 15 shows the coefficients of the diffracting structure formed on the surface 150a of the objective lens 160.

TABLE 15

| | COEFFICIENT OF OPTICAL | | | | |
|---|---|---|---|---|---|
| SURFACE | PATH DIFFERENCE FUNCTION | | | | |
| No. | P2 | P4 | P6 | P8 | P10 |
| 1 (h ≦ 1.300) | −2.5800E−01 | −8.1450E+00 | 1.6270E+00 | −6.7270E−01 | 1.8470E−01 |
| 1 (h ≦ 1.825) | −1.0649E+01 | 8.7060E+00 | −6.7640E+00 | 1.5810E+00 | −1.1210E−01 |

As shown in Tables 13 to 15, the surface 160a of the objective lens 160 has an inner area (h≦1.300) and an outer area (1.300<h≦1.825). Aspherical shapes of the inner area and the outer area are different from each other. Diffracting structures of the inner area and the outer area are different from each other.

Table 16 lists values of d′/(ML′) of the optical systems 10β according to the second to fourth examples. As shown in Table 16, all of the optical systems 10β according to the second to fourth examples satisfy the condition (1) at least for the optical system 20A having a relatively high recording density.

TABLE 6

| | Optical Disc 20A | Optical Disc 20B |
|---|---|---|
| 2^{nd} EXAMPLE | −0.70 | −0.71 |
| 3^{rd} EXAMPLE | −0.57 | −0.58 |
| 4^{th} EXAMPLE | −0.62 | −0.64 |

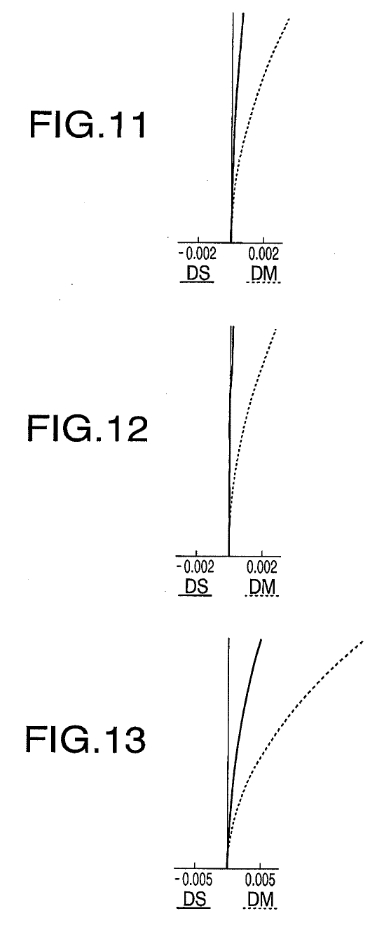

FIG. 11 shows a graph of astigmatism caused in the optical system 10β according to the second example when the maximum object height of the objective lens 130 is 400 μm. FIG. 12 shows a graph of astigmatism caused in the optical system 10β according to the third example when the maximum object height of the objective lens 150 is 400 μm. FIG. 13 shows a graph of astigmatism caused in the optical system 10β according to the fourth example when the maximum object height of the objective lens 160 is 400 μm.

Since the optical systems 10β according to the second to fourth examples do not need a coupling lens, cost reduction and downsizing can be achieved. Since each of the optical system 10β according to the second to fourth examples satisfies the condition (1) at least when the optical disc 20A having a relatively high recording density is used, astigmatism caused in the tracking operation can be effectively suppressed. In other words, the optical system 10β according to the second to fourth examples is able to form a small beam spot suitable for recording and reproducing operations for the optical disc 20A, on the recording surface of the optical disc 20A.

Although the present invention has been described in considerable detail with reference to certain preferred embodiments thereof, other embodiments are possible.

For example, a cover glass for protecting a light source, a beam splitter, and etc. may be located between the light source and the objective lens in each of the above mentioned concrete examples.

This application claims priority of Japanese Patent Application No. P2006-114337 filed on Apr. 18, 2006. The entire subject matter of the application is incorporated herein by reference.

What is claimed is:

1. An optical system for an optical disc drive, comprising:
a light source that emits a light beam; and
an objective lens to which the light beam emitted by the light source enters,
wherein the light beam emitted by the light source is incident on the objective lens without passing through a coupling lens,
wherein the optical system satisfies a condition:
−0.70≦d′/(ML′)≦−0.57 (1)
where d′ (mm) represents a center thickness of the objective lens corresponding to air, M represents magnification of the optical system, and L′ (mm) represents an object-to-image distance corresponding to air.

2. An optical system for an optical disc drive for recording data to and/or reproducing data from at least two types of optical discs having different thicknesses of cover layers, comprising:
a light source having light emitting portions which emit light beams having wavelengths respectively corresponding to the at least two types of optical discs; and
an objective lens to which the light beams emitted by the light source enter,
wherein each of the light beams emitted by the light source is incident on the objective lens without passing through a coupling lens,
wherein the optical system satisfies a condition:
−0.70≦d′/(ML′)≦−0.57 (1)
where d′ (mm) represents a center thickness of the objective lens corresponding to air, M represents magnification defined in a state where a light beam emitted by the light source is converged onto a recording surface of an optical disc having a relatively thin cover layer with almost no aberration, and L′ (mm) represents an object-to-image distance corresponding to air.

3. The optical system according to claim 2, wherein the light emitting portions are arranged along a line which is perpendicular to a first direction, in which the objective lens is allowed to move perpendicularly to a recording surface of an optical disc being used, and is perpendicular to a second direction in which the objective lens is allowed to move in parallel with the recording surface of the optical disc being used.

4. An optical system for an optical disc drive, comprising:
a light source that emits a light beam; and
an objective lens to which the light beam emitted by the light source enters,
wherein the light beam emitted by the light source is unrefracted by a lens and incident on the objective lens,
wherein the optical system satisfies a condition:
−0.70≦d′/(ML′)≦−0.57 (1)
where d′ (mm) represents a center thickness of the objective lens corresponding to air, M represents magnification of the optical system, and L′ (mm) represents an object-to-image distance corresponding to air.

5. An optical system for an optical disc drive for recording data to and/or reproducing data from at least two types of optical discs having different thicknesses of cover layers, comprising:
a light source having light emitting portions which emit light beams having wavelengths respectively corresponding to the at least two types of optical discs; and
an objective lens to which the light beams emitted by the light source enter,
wherein each of the light beams emitted by the light source is unrefracted by a lens and incident on the objective lens,
wherein the optical system satisfies a condition:
−0.70≦d′/(ML′)≦−0.57 (1)
where d′ (mm) represents a center thickness of the objective lens corresponding to air, M represents magnification defined in a state where a light beam emitted by the light source is converged onto a recording surface of an optical disc having a relatively thin cover layer with almost no aberration, and L′ (mm) represents an object-to-image distance corresponding to air.
